(19) United States
(12) Patent Application Publication
(10) Pub. No.: US 2008/0013939 A1
(43) Pub. Date: Jan. 17, 2008

(54) ANTI-SHAKE APPARATUS

(75) Inventor: Takahiro OGAWA, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/776,757

(22) Filed: Jul. 12, 2007

(30) Foreign Application Priority Data
Jul. 13, 2006 (JP) 2006-192907

(51) Int. Cl. G03B 17/00; H04N 5/228

(52) U.S. Cl. 396/55; 348/208.2; 348/E05.031

(57) ABSTRACT

An anti-shake apparatus is provided for correcting an image blur of an object image which is formed on an imaging sensor by an optical system. The apparatus has a fixed unit that is fixed to a body of a photographing apparatus and a movable unit that is movably held by the fixed unit, an angular velocity sensor that senses an angular velocity so as to detect the shake quantity of the body, and a driver that moves the movable unit according to the detected shake quantity. At least a part of the optical system or the imaging sensor is mounted on the movable unit. The angular velocity sensor is attached to one of the fixed unit and movable unit.

### BACKGROUND OF THE INVENTION

1. Field of the Invention

The present invention relates to an anti-shake apparatus which has an angular velocity sensor whose arrangement is improved.

2. Description of the Related Art

Conventionally, it is known that an anti-shake apparatus is often provided in a photographing device such as a digital camera. The anti-shake apparatus moves an imaging sensor or a correcting lens system in a plane which is perpendicular to the optical axis, by an amount corresponding to the shake quantity of the camera body, so as to reduce the image blur in the image-forming plane.

The anti-shake apparatus has a movable unit on which the imaging sensor or the correcting lens system is mounted, a fixed unit which movably holds the movable unit, and an angular velocity sensor for detecting the shake quantity of the camera body. The movable unit is moved together with the imaging sensor or the correcting lens system according to the shake quantity detected by the angular velocity sensor, so that any image blur in the imaging sensor is reduced.

A photographing apparatus such as a digital camera has a main substrate, on which several circuits, including a CPU and the angular velocity sensor, are mounted. Generally, the main substrate is disposed in the camera body separately from the movable and fixed units.

However, the main substrate is usually very thin, with the aim of reducing the weight thereof, so consequently it is not very stiff. Therefore, when a shock in the camera body is caused by the opening and closing motion of the shutter, by an external force, or by any other force, the main substrate is easily bent. This results in the shock, which is often amplified, then being transmitted to the angular velocity sensor. The amplified shock causes the noise generated in the angular velocity sensor to increase. Due to this increase in noise, it is necessary to conduct an additional noise elimination process in order to determine the shake quantity correctly.

Further, in photographing apparatus having a big camera body, such as a single-lens reflex camera, the main substrate is located away from the imaging sensor. Therefore, the shake quantity which is detected by the angular velocity sensor sometimes greatly differs from the shake quantity which is actually generated at the imaging sensor or the correcting lens system, which disturbs the accuracy of the anti-shake operation.

### SUMMARY OF THE INVENTION

Therefore, an object of the present invention is to provide an anti-shake apparatus which prevents the noise generated by the angular velocity sensor from increasing, and which accurately detects the actual shake quantity of the imaging sensor or correcting lens system.

According to the present invention, an anti-shake apparatus is provided for correcting the image blur of an object image which is formed on an imaging sensor by an optical system. The apparatus has a fixed unit that is fixed to a body of a photographing apparatus and a movable unit that is movably held by the fixed unit, an angular velocity sensor that senses an angular velocity so as to detect the shake quantity of the body, and a driver that moves the movable unit according to the detected shake quantity in order to correct the image blur. At least a part of the optical element or the imaging sensor is mounted on the movable unit. The angular velocity sensor is attached to one unit of the fixed unit and movable unit.

### BRIEF DESCRIPTION OF THE DRAWINGS

The objects and advantages of the present invention will be better understood from the following description, with reference to the accompanying drawings in which:

FIG. 1 is a perspective view of a photographing apparatus;

FIG. 2 is an exploded perspective view of an anti-shake unit in the first embodiment as viewed from the front surface side of a first yoke;

FIG. 3 is an exploded perspective view of an anti-shake unit in the first embodiment as viewed from the back surface side of a second yoke; and

FIG. 4 is an exploded perspective view of an anti-shake unit in the second embodiment as viewed from the back surface side of a second yoke.

### DESCRIPTION OF THE PREFERRED EMBODIMENTS

The present invention will be described below with reference to the embodiments shown in the drawings.

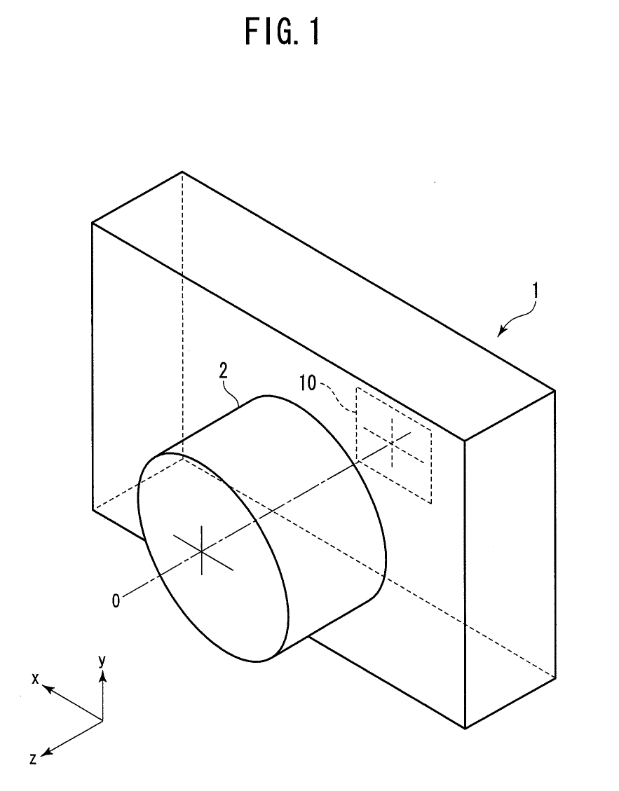

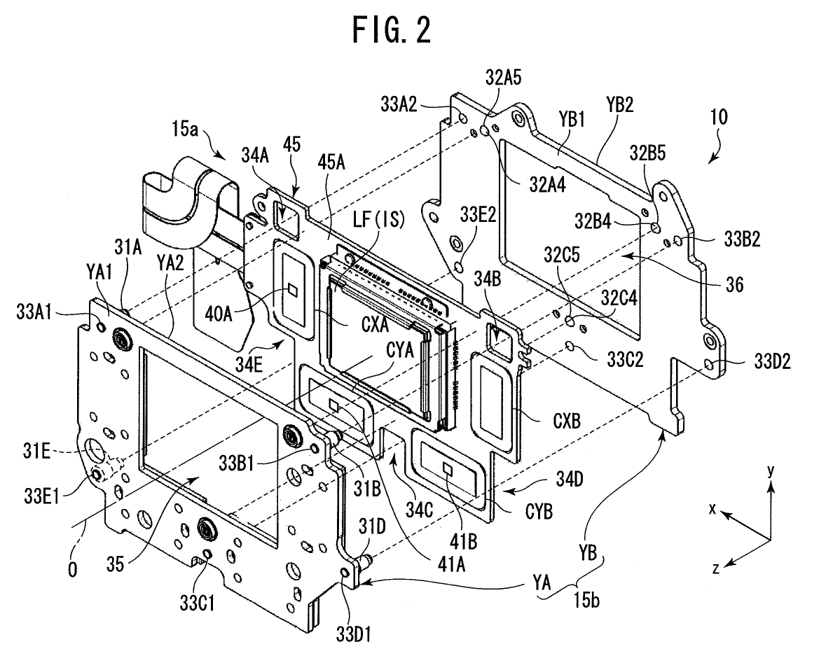

The first embodiment of this invention is explained below using FIGS. 1-3. Further, the below explanation will be described assuming the photographing apparatus is a digital camera.

Further, hereafter in this specification, “front side” means the objective side of the photographing lens system and “back side” means the opposite side to the objective side taken along the optical axis of the photographing lens system. Therefore, the front surface means a surface orienting to the objective side and the back surface means a surface orienting to the opposite side.

The digital camera has a camera body 1, which has a lens barrel 2 and an anti-shake unit 10 therein. The barrel lens 2 includes a photographing lens system (not shown in the figure), namely an optical system, therein, and the photographing lens system has an optical axis O.

Hereinafter, a horizontal direction which is perpendicular to the optical axis O is defined as the “first direction x”, a vertical direction which is perpendicular to the optical axis O and perpendicular to the first direction x is defined as the “second direction y”, and a horizontal direction which is parallel to the optical axis O is defined as the “third direction z”.

The anti-shake unit 10 includes a movable unit 15a having a movable substrate 45, and a fixed unit 15b which is fixed to the camera body 1. The movable unit 15a further has a low-pass filter LF, an imaging sensor IS such as a CCD, etc., first and second horizontal driving coils CXA and CXB, first and second vertical driving coils CYA and CYB, a horizontal hall element 40A, first and second vertical hall elements 41A and 41B, and angular velocity sensors 61 and 62, such as gyro sensors, which are mounted on the movable substrate 45.

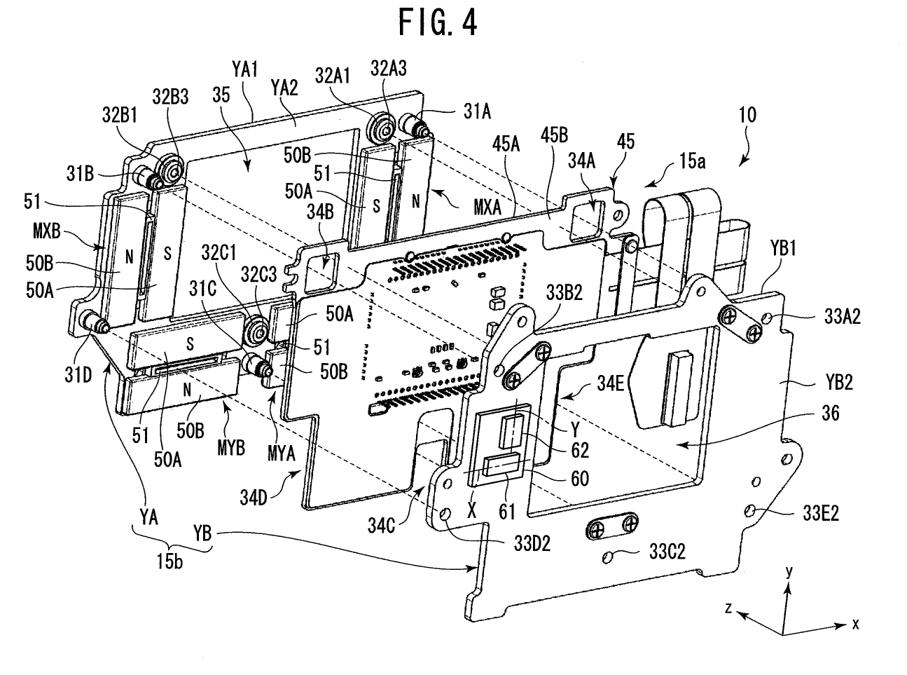

The fixed unit 15b has first and second yokes (first and second fixed substrates) YA and YB, first to fifth poles 31A-31E (see FIG. 4), a plurality of balls, a plurality of ball receivers, first and second horizontal magnetic field generators MXA and MXB, and first and second vertical magnetic field generators MYA and MYB.

The object image is formed in the imaging field of the imaging sensor IS as an optical image by the photographing lens system. The optical image which is formed on the imaging sensor is converted to an image signal by the imaging sensor IS. The display image corresponding to the imaging signal is indicated on the display of the camera after an A/D converting operation and an image processing operation. Further, the image signal is stored in the memory, after the A/D converting operation and the image processing operation. Additionally, “imaging field” means an are a which can receive the light from the object to form the optical image thereon and which can convert the received light into the imaging signal.

The anti-shake unit 10 is an apparatus that reduces the effect of hand-shake by moving a movable unit 15a in a plane (herein after “plane xy”) perpendicular to an optical axis O, by canceling the lag corresponding to the hand-shake quantity, of a object image in the imaging field of the imaging sensor IS, and by stabilizing the object image that reaches the imaging field of the imaging sensor IS.

The movable substrate 45 is disposed in a plane perpendicular to the optical axis O. The imaging sensor IS is mounted on a front surface 45A of the movable substrate 45. The low-pass filter LF is disposed on the front side of the imaging sensor IS.

In an initial state, namely before the movable unit 15a starts to move for anti-shake operation, the movable substrate 45 is disposed at a center position such that the optical axis O passes through the center of the imaging field of the imaging sensor IS, and the sides of the rectangular imaging field are squarely aligned in the first direction x and the second direction y. Further, the movable unit 15a is disposed at the center position by the electro-magnetic force generated by an electric current input to the coils.

The movable substrate 45, namely the movable unit 15a, is interposed between the first and second yoke YA and YB such that the movable unit 15a is movably held by the fixed unit 15b through the plurality of balls. The movable unit 15a can move in the plane xy between the first and second yokes YA and YB.

The first and second yokes YA and YB, which are magnetic metal plates, lie in a plane perpendicular to the third direction z, namely the optical axis O. The first yoke YA is arranged at the front side of the movable substrate 45, and the second yoke YB is arranged at the back side of the movable substrate 45. The first and second yokes YA and YB are fixed to the camera body 1. The first to fifth poles 31A-31E, which extend in a direction parallel to the third direction z, are disposed between the first and second yokes YA and YB.

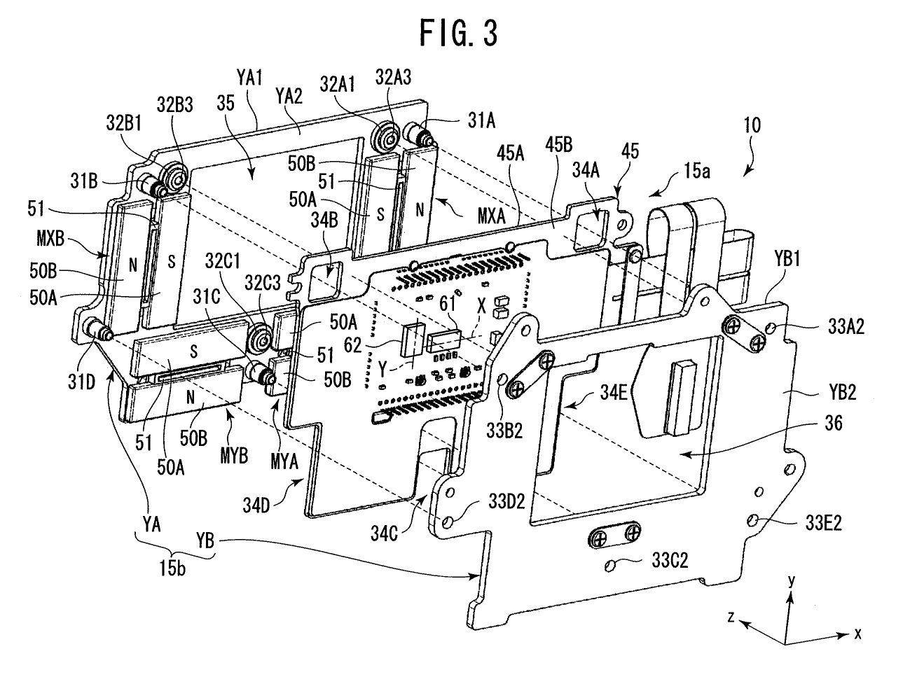

As shown in FIG. 3, the first and second angular velocity sensors 61 and 62 are attached to the back surface 45B of the movable substrate 45 which faces the second yoke YB and which is the opposite surface to the front surface 45A. The first and second angular velocity sensors 61 and 62 are adjacently arranged in the first direction x. The first angular velocity sensor 61 is arranged on the right side of the second angular velocity sensor 62, when viewed from the back side. The first angular velocity sensor 61, aligned in the first direction x, senses a first angular velocity vx about an axis X, which is parallel to the first direction x. The second angular velocity sensor 62, aligned in the second direction y, senses a second angular velocity vy about an axis Y, which is parallel to the second direction y. The first angular velocity vx is used for calculating the movement quantity of the movable unit 15a (imaging sensor IS) in the second direction y, in order to correct the image blur in that direction. Similarly, the second angular velocity vy is used for calculating the movement quantity of the movable unit 15a (imaging sensor IS) in the first direction x.

Viewed from the front side or the back side, both the first and second angular velocity sensors 61 and 62 coincide with the imaging field of the imaging sensor IS, but do not overlap the center of the imaging field. Both the first and second angular velocity sensors 61 and 62 are displaced on the left side of the center of the imaging field, when viewed from the front side. However, it is possible for one of the first and second angular velocity sensors 61 and 62 to overlap the center of the imaging field. Further, the first and second angular velocity sensors 61 and 62 may be adjacently arranged in the first or second direction, such that the center of the imaging field is located between the sensors 61 and 62.

The second yoke YB has a hole 36, which is located at a position corresponding to the imaging sensor IS. The pins or terminals of the imaging sensor IS which project from the back surface 45B of the movable substrate 45 and the first and second angular velocity sensors 61 and 62 are disposed within the hole 36.

In the camera body 1, a main substrate (not shown in the figures) is provided on the back side of the second yoke YB, intersecting the optical axis O. A CPU which controls the main operation of the digital camera, an imaging process circuit which processes the images, an AE circuit which controls the exposure of the imaging sensor IS, an AF circuit which controls the focus of the photographing lens system, and so on are mounted on the main substrate. The main substrate is very thin, so its stiffness is lower than that of the first and second yokes YA and YB, and it is easily bent by stress.

One end of each of the first to fifth poles 31A-31E is mounted to the first to fifth mounting portions 33A1-33E1 of the first yoke YA. The other ends of the first to fifth poles 31A-31E are mounted to the sixth to tenth mounting portions 33A2-33E2 of the second yoke YB. The first yoke YA is separated from the second yoke YB by a constant distance due to the first to fifth poles 31A-31E.

The substrate 45 has first to fifth restraint portions 34A-34E, which are an opening such as a hole, an indentation or a notch. The first to fifth poles 31A-31E are inserted through the first to fifth restraint portions 34A-34E, respectively. The first to fifth restraint portions 34A-34E prevent the movable unit 15a from moving outside a predetermined range by the inner periphery of at least one of the first to fifth restraints 34A-34E contacting the first to fifth poles 31A-31E at the limit of the predetermined range. Namely, the movable unit 15a can move within the predetermined range in the plane xy, but cannot move outside the predetermined range.

In the state when the power of the digital camera is off, an electromagnetic force is not generated by the coil and magnetic field generator, so the movable unit 15a is not held in a specific position by electromagnetic force. Therefore, the movable unit 15a is moved in the plane xy by a gravitational force, until at least one of the first to fifth poles 31A-31E meets the inner periphery of at least one of the first to fifth restraints 34A-34E. Namely, the movable unit 15a is held by the fixed unit 15b at the point where the inner periphery contacts the restraint portions, in this case.

The first yoke YA has first to third ball receivers 32A1-32C1 which are provided on a back surface YA2 facing the movable substrate 45. First to third balls 32A3-32C3 are rotatably provided in the first to third ball receivers 32A1-32C1, respectively.

The second yoke YB has fourth to sixth ball receivers 32A5-32C5, which are provided on a front surface YB1 which faces the movable substrate 45 and which is the opposite surface to the back surface YB2. Fourth to sixth balls 32A4-32C4 are rotatably provided in the fourth to sixth ball receivers 32A5-32C5, respectively. Each of the fourth to sixth ball receivers 32A5-32C5 is disposed on a line, parallel to the third direction z, which also passes through each of the first to third ball receivers 32A1-32C1.

A pressure probe (not shown in Figs.) is screwed into each of the first to third ball receivers 32A1-32C1. The pressure probes push the movable substrate 45 away from the first yoke YA through the first to third balls 32A3-32C3, so that the movable substrate 45, namely the movable unit 15a, which is interposed between the first and second yokes YA and YB, is movably held by the yokes YA and YB through the balls 32A3-32C3 and 32A4-32C4.

The first yoke YA has a hole 35 which is disposed at a position corresponding to the imaging sensor IS, in order not to obstruct any incident light which passes into the imaging field of the imaging sensor IS.

The first and second horizontal magnetic field generators MXA and MXB, which are arranged on either side of the hole 35 in the first direction x, aligned in the second direction y, are fixed to the back surface YA2 of the first yoke YA. The first and second vertical magnetic field generators MYA and MYB, which are arranged below the hole 35 aligned and adjacent in the first direction x, are fixed to the back surface YA2.

The horizontal magnetic field generators MXA and MXB have first and second magnets 50A and 50B aligned in the second direction y, and a spacer 51 composed of a nonmagnetic body. The first and second magnets 50A and 50B, which are adjacently arranged in the first direction x, are bonded through the spacer 51.

The vertical magnetic field generators MYA and MYB have first and second magnets 50A and 50B aligned in the first direction x, and a spacer 51 composed of a nonmagnetic body. The first and second magnets 50A and 50B, which are adjacently arranged in the second direction y, are bonded through the spacer 51. The back side (namely, the movable substrate 45 side) of the first magnet 50A is the south pole, and the front side (namely, the photographing lens system side) thereof is the north pole. On the other hand, the back side of the second magnet 50B is the north pole, and the back side thereof is the south pole. Namely, the north and south poles of the second magnet 50B are disposed conversely in the third direction z to those of the first magnet 50A.

The first and second horizontal driving coils CXA and CXB, which are arranged on either side of the imaging sensor IS in the first direction x, aligned in the second direction y, are fixed to the front surface 45A of the movable substrate 45 facing the first yoke YA. The first and second vertical driving coils CYA and CYB, which are arranged below the imaging sensor IS aligned and adjacent in the first direction x, are fixed to the front surface 45A.

The horizontal hall element 40A is provided at the center position of the first horizontal driving coil CXA, but no hall element is provided on the center position of the second horizontal driving coil CXB. The first and second vertical hall elements 41A and 41B are provided at the center position of the first and second vertical driving coils CYA and CYB, respectively.

The first horizontal driving coil CXA and the horizontal hall element 40A face the first horizontal magnetic field generator MXA in the third direction z. The second horizontal driving coil CXB faces the second horizontal magnetic field generators MXB in the third direction z.

The first vertical driving coil CYA and the first horizontal hall element 41A face the first vertical magnetic field generator MYA in the third direction z. The second vertical driving coil CYB and the second horizontal hall element 41B face the second vertical magnetic field generator MYB in the third direction z.

The coil pattern of the first horizontal driving coil CXA has a line segment which is parallel to the second direction y, so that the movable unit 15a, which includes the first horizontal driving coil CXA, moves in the first direction x by electro-magnetic force generated from an electric current input to the coil CXA and a magnetic field generated by the first horizontal magnetic field generator MXA.

The coil pattern of the second horizontal driving coil CXB has a line segment which is parallel to the second direction y, so that the movable unit 15a, which includes the second horizontal driving coil CXB, moves in the first direction x by electromagnetic force generated from an electric current input to the coil CXB and a magnetic field generated by the second horizontal magnetic field generator MXB.

The coil pattern of the first vertical driving coil CYA has a line segment which is parallel to the first direction x, so that the movable unit 15a, which includes the first vertical driving coil CYA, moves in the second direction y by electro-magnetic force generated from an electric current input to the coil CYA and a magnetic field generated by the first vertical magnetic field generator MYA.

The coil pattern of the second vertical driving coil CYB has a line segment which is parallel to the first direction x, so that the movable unit 15a, which includes the second vertical driving coil CYB, moves in the second direction y by electro-magnetic force generated from an electric current input to the coil CYB and a magnetic field generated by the second vertical magnetic field generator MYB.

The first and second yokes YA and YB make up a magnetic circuit containing the magnetic field generators MXA, MXB, MYA and MYB so that the magnetic-flux density between the first horizontal driving coil CXA and the first horizontal magnetic field generator MXA is increased. Similarly, the magnetic-flux density between the second horizontal driving coil CXB and the second horizontal magnetic field generator MXB, the magnetic-flux density between the first vertical driving coil CYA and the first vertical magnetic field generator MYA, and the magnetic-flux density between the second vertical driving coil CYB and the second vertical magnetic field generator MYB are increased.

In the anti-shake apparatus of this embodiment, the first and second angular velocity sensors 61 and 62 sense the first and second angular velocities vx, and vy of the camera body per predetermined time (for example 1 ms), respectively. The sensed first and second angular velocities vx, and vy are sent to the CPU (not shown in Figs.) as the sensed signal. At the CPU, the shake quantity (namely, the movement quantity) of the camera body in the second and first directions y and x for the predetermined time (1 ms) is calculated based on the first and second angular velocities vx and vy, respectively. A target position to which the imaging sensor should move in order to correct the image blur is then calculated according to the above shake quantities.

After calculating the target position, an electric current is input to each coil so that the movable unit 15a is moved in the directions x and y by the electromagnetic force generated by the inputting electric current and the magnetic fields of the generators MXA, MXB, MYA, and MYB, in order to move the imaging sensor IS to the target position.

The horizontal hall element 40A senses the magnetic field which is generated by the first horizontal magnetic field generator MXA so that the CPU detects the position in the first direction x of the hall element 40A relative to the magnetic field generator MXA. Namely, the CPU detects the position in the first direction of the movable unit 15a relative to the fixed unit 15b. Similarly, the first and second vertical hall elements 41A and 41B sense the magnetic fields which are generated by the first and second vertical magnetic field generators MYA and MYB, respectively, so that the CPU detects the position in the second direction y of the movable unit 15a relative to the fixed unit 15b.

The CPU calculates the movement quantity of the movable unit 15a relative to the fixed unit 15b based on the detected position of the movable unit 15a in the first and second directions x and y. The CPU adjusts the amount of electric current input to each coil, referring to the movement quantity, so as to move the imaging sensor IS to the target position for reducing image blur in the imaging sensor IS.

Next, the effect of the anti-shake apparatus in this embodiment will be explained. As described above, the first and second angular velocity sensors 61 and 62 sense the angular velocities about the axes of the first and second directions x and y, respectively. Therefore, theoretically, the first and second angular velocity sensors 61 and 62 do not detect movement in the xy plane, so a sensed signal would not be output from the sensors 61 and 62 when the movable unit 15a is moved in the xy plane. However, when movement of the movable unit 15a in the plane xy occurs, the first and second angular velocity sensors 61 and 62 actually output the sensed signal as a noise signal.

Additionally, the movable unit 15a on which the first and second angular velocity sensors 61 and 62 are mounted is movably held between the two yokes of the fixed unit 15b with a small inward force. Therefore, movement in the plane xy of the camera body does not detrimentally transfer to the movable unit 15a from the fixed unit 15b. This prevents the angular velocity sensors 61 and 62 from moving in the plane xy together with the movement of the camera body, which reduces the noise signal when a shock is caused in the camera body by the opening and closing motion of the shutter, an external force, or any other force.

Further, the movable unit 15a moves negligibly in the third direction z relative to the two yokes of the fixed unit 15b, because it is sandwiched by the fixed unit 15b in the third direction z. Namely, the movable unit 15b moves in the third direction z quickly and exactly in response to the movement of the camera body in the third direction z.

Therefore, when the camera body is shaken or swung around the axis X or Y, the movable unit 15b is shaken or swung around the axis X or Y quickly and exactly in response to the shake or swing of the camera body. This enables the angular velocity sensors 61 and 62 to sense the angular velocity vx and vy accurately, as required.

In the anti-shake apparatus of the present embodiment, the angular velocity sensors 61 and 62 are disposed at the same position in the first and second directions x and y on the back surface 45B of the movable substrate 45 so that the angular velocity sensors 61 and 62 are disposed close to the imaging sensor IS. Therefore, the shake of the imaging device IS can be correctly identified.

Furthermore, the number of the circuits which are mounted on the movable substrate 45 is less than the number of circuits which are mounted on the main substrate, so the heat generated by the circuits on the movable substrate 45 is less than those of the main substrate. Therefore, the angular velocity sensors 61 and 62 are not affected by the heat as much, which prevents detection errors in the angular velocity sensors 61 and 62.

FIG. 4 shows the anti-shake unit according to the second embodiment. The difference of the second embodiment from the first embodiment is the position where the angular velocity sensors 61 and 62 are arranged. The difference will be explained below.

In this embodiment, the first and second angular velocity sensors 61 and 62 and a sensor substrate 60 are located on the fixed unit 15b, not on the movable unit 15a.

Viewed from the back side, the sensor substrate 60 is fixed on the left side of the hole 36 on the back surface YB2 of the second yoke YB. The first and second angular velocity sensors 61 and 62 are attached to the sensor substrate 60. Namely, the first and second angular velocity sensors 61 and 62 are located at the nearest position to the imaging sensor IS in the back surface YB2 of the second yoke YB (fixed substrate). The first and second angular velocity sensors 61 and 62 are adjacently arranged in the second direction y, such that the second angular velocity sensor 62 is positioned above the first angular velocity sensor 61. The first and second angular velocity sensors 61 and 62, which are aligned in the first and second directions x and y, respectively, sense first and second angular velocities vx and vy about the axes X and Y, respectively.

Next, the effect of the anti-shake apparatus of this second embodiment will be explained. As described above, the first and second angular velocity sensors 61 and 62 are attached to the second yoke YB of which the stiffness is greater than that of the main substrate where the CPU and other circuits are fixed. Therefore, when a shock is caused in the camera body, the second yoke YB2 is not bent as much when compared with the main substrate, which prevents noise in the signal being detected by the first and second angular velocity sensors 61 and 62.

Further, the shake quantity around the axes X and Y of the camera body can be accurately detected by the sensors 61 and 62, which are mounted on the second yoke YB, because the second yoke YB has a greater stiffness and is not bent easily by external forces.

In this embodiment, the first and secondangularvelocity sensors 61 and 62 are mounted on the second yoke YB2, which is the substrate closet to the movable substrate 45 in the third direction z, so detection errors in the angular velocity sensors 61 and 62 become small, similar to the first embodiment. Further, the angular velocity sensors 61 and 62 are not influenced by heat generated by the other circuits because none of the other circuits are mounted on the second yoke YB.

In this embodiment, the imaging sensor IS is mounted on the substrate 45 of the movable unit 15a, so that the imaging sensor IS is moved together with the movable unit 15a in the plane xy in order to correct the image blur. However, the imaging sensor IS may not be mounted on the movable unit 15a and may not move with the movable member 15a. In this case, a correcting lens system is mounted on the movable unit 15a instead of the imaging sensor IS, so that the correcting lens system is moved in the plane xy to correct the image blur. Further, the correcting lens system is a part of the photographing lens system.

Although the embodiments of the present invention have been described herein with reference to the accompanying drawings, obviously many modifications and changes can be made by those skilled in this art without departing from the scope of the invention.

The present disclosure relates to subject matter contained in Japanese Patent Application No. 2006-192907 (filed on Jul. 13, 2006) which is expressly incorporated herein, by reference, in its entirety.

1. An anti-shake apparatus for correcting an image blur of an object image which is formed on an imaging sensor by an optical system, comprising:
a fixed unit that is fixed to a body of a photographing apparatus;
a movable unit that is movably held by said fixed unit, one of at least a part of said optical system and said imaging sensor being mounted on said movable unit;
an angular velocity sensor that senses an angular velocity so as to detect a shake quantity of said body; and
a driver that moves said movable unit according to the detected shake quantity in order to correct the image blur;
wherein said angular velocity sensor is attached to one of said fixed unit and said movable unit.

2. An apparatus according to claim 1, wherein said movable unit comprises a movable substrate having a front surface on which said imaging sensor is mounted and a back surface which is an opposite surface to said front surface, said angular velocity sensor being mounted on said back surface.

3. An apparatus according to claim 2, wherein the position of said angular velocity sensor coincides with that of an imaging field of said imaging sensor, when viewed from said front surface side.

4. An apparatus according to claim 2, wherein said angular velocity sensor overlaps the center of an imaging field of said imaging sensor, when viewed from said front surface side.

5. An apparatus according to claim 1, wherein said movable unit is capable of moving in a plane which is perpendicular to an optical axis of said optical element,
said angular velocity sensor comprising a first element that senses a first angular velocity about an axis of a first direction which is perpendicular to said optical axis, and a second element that senses a second angular velocity about an axis of a second direction which is perpendicular to both said optical axis and said first direction.

6. An apparatus according to claim 1, wherein said fixed unit has a fixed substrate that is disposed close to said movable unit and disposed at a back side of said movable unit, and said angular velocity sensor is attached to a back surface of said fixed substrate.

7. An apparatus according to claim 6, wherein said angular velocity sensor is located at the nearest position to said imaging sensor in said back surface of said fixed substrate.

8. An apparatus according to claim 1, wherein said fixed unit has a fixed substrate composed of a metal plate, and said angular velocity sensor is attached to said fixed substrate.

9. An apparatus according to claim 1, wherein said movable unit comprises a movable substrate having a front surface on which said imaging sensor is mounted and a back surface which is an opposite surface to said front surface,
said fixed unit comprising first and second fixed substrates that are disposed at said front and back sides of said movable substrate, respectively,
said movable substrate interposed between said first and second fixed substrate such that said movable substrate is movably held by said first and second fixed substrates,
said angular velocity sensor being attached to a back surface of said second fixed substrate.
